(19) United States
(12) Patent Application Publication
(10) Pub. No.: US 2025/0033068 A1
(43) Pub. Date: Jan. 30, 2025

(54) PAINT TANK-EQUIPPED ELECTROSTATIC COATING DEVICE

(71) Applicant: ABB Schweiz AG, Baden (CH)

(72) Inventor: Kuniharu Yamauchi, Tokyo (JP)

(21) Appl. No.: 17/755,273

(22) PCT Filed: Jun. 11, 2020
(86) PCT No.: PCT/JP2020/023051

§ 371 Date: Apr. 25, 2022

(51) Int. Cl. B05B 5/16; B05B 5/03; B05B 5/053; B05B 13/04; B05B 15/55

(52) U.S. Cl. CPC B05B 5/16; B05B 5/03; B05B 5/0531; B05B 15/55; B05B 13/0431

(57) ABSTRACT

A paint tank-equipped electrostatic coating device includes a paint tank device which is provided in a housing and supplies paint stored in a paint chamber to a rotary atomizing head through a pint flow path. In addition, the electrostatic coating device includes a tank cleaning flow path which supplies a cleaning flow for cleaning the paint chamber of the paint tank device, and a control unit which performs control of cleaning the paint chamber after the coating by a coating machine is completed until a paint inflow port of the housing is connected to a color change valve unit.

### FIELD

The present disclosure relates to a paint tank-equipped electrostatic coating device that sprays paint stored in a paint tank device toward the coated object.

### BACKGROUND

Electrostatic coating device is used to improve the coating efficiency when coating coated objects such as automobile bodies. The electrostatic coating device performs coating by applying a high voltage to the paint. In addition, in the recent coating device, in order to be environmentally conscious, the use of solvents such as thinners is restrained, and water-based paints are used. However, when using water-based paints, the high voltage applied may leak through the water-based paint in the paint supply flow path from the coating device to the paint supply source. Thereby, coating devices using water-based paints cannot perform coating by directly applying a high voltage to the paint.

Therefore, in electrostatic coating devices, some devices have canceled the paint supply flow path which is the main cause of high-voltage leakage. The coating device is a cartridge-type electrostatic coating device, which can suppress high-voltage leakage even when high voltage is directly applied to water-based paints.

The cartridge-type electrostatic coating device includes: a housing which front side is a coating machine mounting portion and which back side is a cartridge mounting portion; a coating machine which is mounted to the coating machine mounting portion and includes an air motor having a hollow rotating shaft; and a rotary atomizing head mounted to the rotating shaft in front of the air motor; a cartridge having a paint tank storing paint and a feed tube extending from the paint tank toward the rotary atomizing head, the feed tube being inserted into the rotating shaft and the tank being mounted to the cartridge mounting portion; a pushing out liquid flow path through which the liquid for pushing out paint stored in the paint tank of the cartridge circulates; and a high voltage generator which is provided in the housing and applies a high voltage to the paint discharged from the feed tube (Patent Literature 1).

Therefore, the cartridge-type electrostatic coating device electrically separates the cartridge paint tank (paint) provided in the housing from the earth to prevent high-voltage leakage.

### CITATION LIST

### Patent Literature

Patent Literature 1: Japanese Unexamined Patent Application Publication No. H 11-262726

### SUMMARY

As described above, in the cartridge-type electrostatic coating device of Patent Literature 1, the paint in the paint tank of the cartridge is pushed out by a liquid. However, there is a problem that in the structure in which liquid is used to push paints out, it is difficult to stabilize the finished state of coating since the supply of paint tank cannot be finely adjusted.

Therefore, for example, it may be considered to provide a paint tank device that mechanically pushes the paint in the paint chamber using power of electric motor or the like. In this case, the paint tank device must discharge and clean the remaining paint and fill the paint from outside for each color change. Since these operations are carried out in the cleaning and filling area far away from the coating area and connected with a special color change valve unit, the color change operation takes time and causes the problem of reduced productivity.

It is an object of an embodiment of the present invention to provide A paint tank-equipped electrostatic coating device which is capable of shortening the time of color change operation to improve the productivity.

According to one embodiment of the present invention, A paint tank-equipped electrostatic coating device includes: a housing having a paint inflow port connected to a color change valve unit for changing the color of the paint; a coating machine which is provided in the housing and includes an air motor having a hollow rotating shaft and a rotary atomizing head mounted to the rotating shaft in front of the air motor; a paint flow path which extending toward the rotary atomizing head in the rotating shaft and through which the paint supplied to the rotary atomizing head circulates; a paint tank device which is provided in the housing and supplies the paint stored in a paint chamber to the rotary atomizing head through the paint flow path; and a high voltage generator which applies a high voltage to the paint discharged from the paint flow path, the paint tank-equipped electrostatic coating device being characterized by including: a tank cleaning flow path which supplies cleaning fluids for cleaning the paint chamber of the paint tank device; a waste liquid discharge flow path configured to discharge the waste liquid flowed out of the paint chamber; and a control device which performs control for cleaning the paint chamber after the coating by the coating machine is completed until the paint inflow port of the housing is connected to the color change valve unit.

According to one embodiment of the present invention, the time of color change operation can be shortened to improve the productivity.

### DESCRIPTION OF DRAWINGS

FIG. 1 is an overall configuration diagram showing a state in which A paint tank-equipped electrostatic coating device according to an embodiment of the present invention is mounted to a coating robot.

FIG. 2 is a schematic diagram showing the paint tank-equipped electrostatic coating device in FIG. 1.

FIG. 3 is an overall configuration diagram showing a state in which the electrostatic coating device is moved to a connection position and connected to the color change valve unit.

FIG. 4 is a time chart showing the color change operation of the paint tank-equipped electrostatic coating device.

### DETAILED DESCRIPTION OF EMBODIMENTS

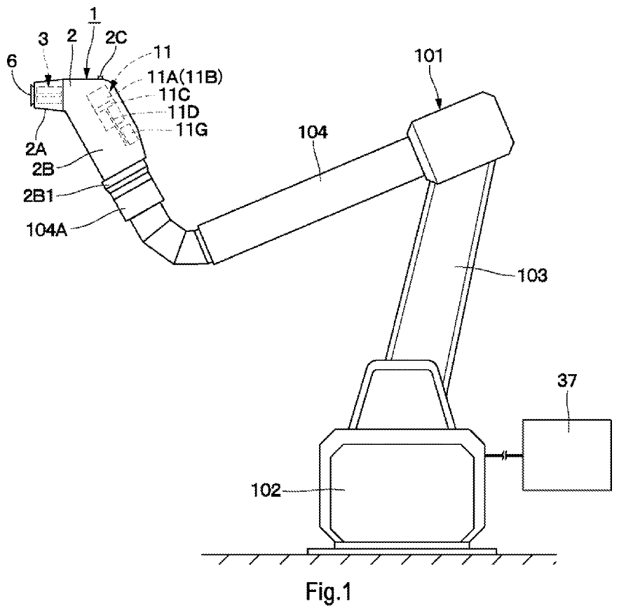

Hereinafter, A paint tank-equipped electrostatic coating device according to an embodiment of the present invention will be described in detail below with reference to FIGS. 1 to 4.

In FIG. 1, the coating robot 101 includes a base 102, a vertical arm 103 operably provided on the base 102 and a horizontal arm 104 rotatably provided at the tip of the vertical arm 103. The tip side of the horizontal arm 104 is a rotatable bracket 104A. The housing 2 of the A paint tank-equipped electrostatic coating device lis mounted to the bracket 104A of the horizontal arm 104. The vertical arm 103 and the horizontal arm 104 may also be provided with other joints capable of rotation or pivoting.

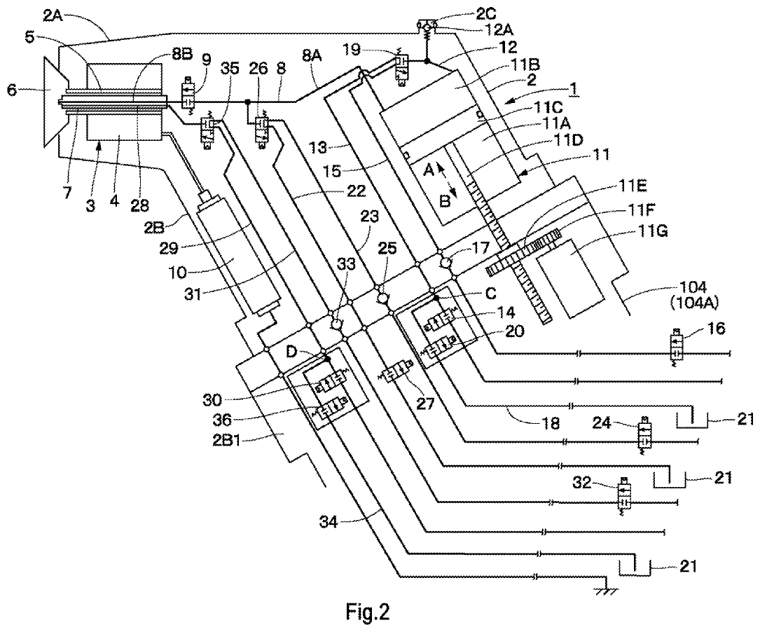

Next, the configuration of the A paint tank-equipped electrostatic coating device 1 according to the embodiment of the present invention will be described in FIG. 2. The electrostatic coating device 1 is a direct charging type electrostatic coating device which directly applies a high voltage to the paint by a high voltage generator 10. Further, the electrostatic coating device 1 includes a rotary atomizing head type coating machine 3 which sprays paint from a rotary atomizing head 6 rotating at a high speed. Further, the electrostatic coating device 1 includes a paint tank device 11 which supplies the stored paint to the rotary atomizing head 6.

The electrostatic coating device 1 is mounted to the tip of the horizontal arm 104 of the coating robot 101. As shown in FIG. 2, the electrostatic coating device 1 includes a housing 2, a coating machine 3, a paint flow path 8, a high voltage generator 10, a paint tank device 11, a tank cleaning flow path 13, a tank cleaning fluid valve 14, a tank side discharge air supply flow path 15, a first check valve 17, a waste liquid discharge flow path 22, a waste liquid discharge fluid supply flow path 23, a second check valve 25, and a control device 37.

The front side of the housing 2 is a coating machine mounting portion 2A for mounting a coating machine. In addition, the housing 2 has a neck portion 2B that is bent and extends from the coating machine mounting portion 2A. The tip of the neck portion 2B is a mounting portion 2B1. In the housing 2, the mounting portion 2B1 of the neck portion 2B is mounted to the bracket 104A constituting the horizontal arm 104 of the coating robot 101.

In addition, the air motor 4 of the coating machine 3 described later is mounted to the coating machine mounting portion 2A. On the other hand, the paint tank device 11 described later is provided on the back side of the housing 2 so as to be borne by the neck portion 2B. Further, in the housing 2, a paint inflow port 2C is provided at a position close to the paint chamber 11B of the paint tank device 11.

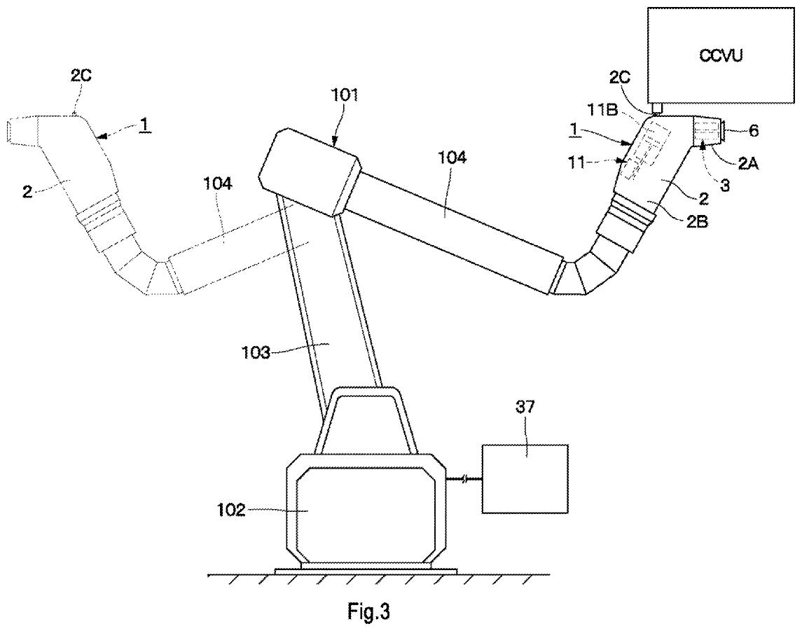

Here, as shown in FIG. 3, the housing 2 is connected to a special color change valve unit (CCVU) in an area where residual paint is cleaned and the next color paint is filled. Specifically, the paint inflow port 2C is connected to the paint outflow port of the CCVU.

The coating machine 3 is mounted to the coating machine mounting portion 2A of the housing 2. The painting machine 3 includes an air motor 4, a rotating shaft 5 and a rotary atomizing head 6. The air motor 4 of the coating machine 3 is mounted to the coating machine mounting portion 2A. The rotating shaft 5 is rotatably supported at the center of the air motor 4. The air motor 4 rotates the rotating shaft 5 and the rotary atomizing head 6 at a high speed of, for example, 3000 rpm-150000 rpm by supplying compressed air for driving from the outside to an air turbine (not shown). In addition, the rotating Shaft 5 is formed as a hollow cylinder. The rotary atomizing head 6 is mounted to the tip (front end) of the rotating shaft 5. In addition, a feed tube 7 described later is inserted through the rotating shaft 5.

The rotary atomizing head 6 of the painting machine 3 is mounted to the rotating shaft 5 in front of the air motor 4. The rotary atomizing head 6 is formed in a cup shape with a diameter extending from the back side to the front side. The rotary atomizing head 6 is rotated at a high speed together with the rotating shaft 5 by the air motor 4 to atomize and spray the paint supplied from the paint tank device 11.

The feed tube 7 is arranged to be inserted through the rotating shaft 5, and its back end side is fixed to the housing 2. On the other hand, the front end side of the feed tube 7 protrudes from the rotating shaft 5 and extends into the rotary atomizing head 6. The feed tube 7 is provided with a paint flow path 8 (atomizing head side flow path 8B) and a cleaning fluid flow path 28 described later.

The paint flow path 8 extends toward the rotary atomizing head 6 in the rotating shaft 5. The paint supplied to the rotary atomizing head 6 flows in the paint flow path 8. The upstream side of the paint flow path 8 is connected to the paint chamber 11B of the paint tank device 11, and the downstream side thereof extends toward the rotary atomizing head 6 in the feed tube 7. In addition to the paint, cleaning fluids (thinner, air) also flow in the paint flow path 8.

In addition, a needle valve 9 is provided in the middle of the paint flow path 8. Thus, the paint flow path 8 consists of a tank side flow path 8A between the paint chamber 11B and the needle valve 9 and an atomizing head side flow path 8B between the needle valve 9 and the feed tube 7. The needle valve 9 is formed as a switching valve, which is closed when discharging waste liquid (residual paint, cleaning liquid) flowing out of the paint chamber 11B of the paint tank device 11 to the waste liquid bath 21, and opened in other cases.

The housing is provided with a high voltage generator 10. The high voltage generator 10 applies a high voltage to the paint discharged from the paint flow path 8 (atomizing head side flow path 8B). The high voltage generator 10 consists of a Cockcroft-Walton circuit for example. The high voltage generator 10 boosts the voltage supplied from a power supply device (not shown) to, for example, −60 kV to −120 kV. The output side of the high voltage generator 10 is electrically connected to the air motor 4 for example. Therefore, the high voltage generator 10 can directly apply high voltage to the paint through the air motor 4, the rotating shaft 5 and the rotary atomizing head 6.

On the other hand, by mounting the paint tank device 11 to the housing 2 and emptied by way of discharging the cleaning fluid or the like in the tank cleaning flow path 13, the waste liquid discharge flow path 22 and the atomizing head cleaning flow path 29, leakage of the high voltage applied to the paint by the high voltage generator 10 is suppressed.

The paint tank device 11 is provided on the back side of the housing 2. The paint tank device 11 supplies the paint stored in the paint chamber 11B described later to the rotary atomizing head 6 through the paint flow path 8. The paint tank device 11 consists of a tank body 11A as a paint tank which is formed as a cylindrical space extending along the neck portion 2B; a piston 11C inserted in the tank body 11A so as to be axially movable and defining an expandable and contractible paint chamber 11B; a screw shaft 11D extending from the piston 11C to the opposite side of the paint chamber 11B; a driven gear 11E rotatably mounted to the housing 2 and whose inner peripheral side is screwed with the screw shaft 11D; a driving gear 11F meshing with the driven gear 11E; and a servo motor 11G that rotates the driving gear 11F. The upstream side of the paint flow path 8 (tank side flow path 8A) is connected to the paint chamber 11B.

In the paint tank device 11, the driven gear 11E can be rotated by rotating the driving gear 11F in one direction (forward rotation) by the servo motor 11G, so that the piston 11C can be moved in the A direction shown by the arrow together with the screw shaft 11D (paint supply). On the other hand, in the paint tank device 11, the piston 11C can be moved in the B direction shown by the arrow by rotating the driving gear 11F in the other direction (reverse rotation) with the servo motor 11G (paint filling).

The filling flow path 12 supplies the next color paint or the like to the paint chamber 11B of the paint tank device 11. The upstream side of the filling flow path 12 is opened at the paint inflow port 2C of the housing 2, and the downstream side thereof is connected to the paint chamber 11B of the paint tank device 11. In addition, the filling flow path 12 is provided with a check valve 12A for preventing the paint from flowing reversely (flowing out). A two-way two-position switching valve may also be used as the check valve 12A.

Next, configurations of the tank cleaning flow path 13, the tank cleaning fluid valve 14, the tank side discharge air supply flow path 15, the first check valve 17, the waste liquid discharge flow path 22, the waste liquid discharge fluid supply flow path 23, the second check valve 25 and the like that are characteristic parts of the present embodiment will be described. They clean the paint remaining in the paint tank device 11 and discharge the remaining cleaning liquid.

The tank cleaning flow path 13 connects a cleaning fluid supply source (not shown) and the filling flow path 12. The downstream side of the tank cleaning flow path 13 is connected to the filling flow path 12 via a gate valve 19 described later and cleaning fluids (cleaning liquid and cleaning air) are supplied to the filling flow path 12 and the paint chamber 11B. For example, a liquid in which thinner, alcohol or the like are mixed into water is used as the cleaning liquid, and compressed air is used as the cleaning air. The tank side discharge air supply flow path 15 described later for supplying cleaning air is connected to the tank cleaning flow path 13.

The tank cleaning flow path 13 is provided with a tank cleaning fluid valve 14. The tank cleaning fluid valve 14 controls the supply and cessation of the cleaning fluid by allowing or cutting off flow in the tank cleaning flow path 13. Moreover, the tank cleaning fluid valve 14 forms a part of the tank side control valves for supplying cleaning fluid. The tank side control valves include a tank cleaning fluid valve 14, a switching valve on the cleaning liquid supply source side and a switching valve on the cleaning air supply source side (none of which are shown).

The tank side discharge air supply flow path 15 may be connected to the tank cleaning flow path 13 via the gate valve 19. Discharge air (compressed air) flows through the tank side discharge air supply flow path 15. The discharge air discharges the cleaning liquid (cleaning fluid) remaining in the tank cleaning flow path 13. The upstream side of the tank side discharge air supply flow path 15 is connected to a discharge air supply source (compressed air source) not shown via a first discharge air supply valve 16 and the downstream side thereof is connected to the gate valve 19. As a result, The tank side discharge air supply flow path 15 may be connected to the downstream end of the tank cleaning flow path 13 via the gate valve 19.

The tank side discharge air supply flow path 15 is provided with a first check valve 17. The first check valve 17 allows the discharge air to circulate toward the paint tank device 11 (gate valve 19) and prevents the reverse flow. As a result, the first check valve 17 prevents the cleaning liquid remaining in the tank side discharge air supply flow path 15 from flowing to the first discharge air supply valve 16 side through the tank side discharge air supply flow path 15.

The upstream side of the tank side cleaning fluid discharge flow path 18 is connected to the tank cleaning flow path 13 at a connection point C located between the tank cleaning fluid valve 14 and the gate valve 19. The connection point C is immediately after the downstream side of the tank cleaning fluid valve 14 in the flow direction of the cleaning fluid. In addition, the downstream side of the tank side cleaning fluid discharge flow path 18 is connected to a waste liquid tank 21 described later.

The gate valve 19 is provided between every two of the filling flow path 12, the tank cleaning flow path 13 and the tank side discharge air supply flow path 15. The gate valve 19 consists of a three-way two-position switching valve and connects the tank cleaning flow path 13 and the tank side discharge air supply flow path 15 at the initial position (basic position) shown in FIG. 2. On the other hand, at the switched position switched from the initial position by the control signal, the filling flow path 12 and the tank cleaning flow path 13 can communicate.

Specifically, at the initial position of the gate valve 19, the discharge air may be supplied from the tank side discharge air supply flow path 15 to the tank cleaning flow path 13. The discharge air from the tank side discharge air supply flow path 15 can discharge the cleaning liquid remaining in the tank cleaning flow path 13. On the other hand, in the switched position of the gate valve 19, cleaning fluids (cleaning liquid and cleaning air) may be supplied from the tank cleaning flow path 13 to the paint chamber 11B of the paint tank device 11 through the filling flow path 12.

The tank side cleaning fluid discharge flow path 18 is provided with a first cleaning fluid discharge valve 20. The first cleaning fluid discharge valve 20 allows or cuts off flow of the tank cleaning flow path 18. When the tank cleaning fluid valve 14 is opened, the first cleaning fluid discharge valve 20 is closed to prevent the cleaning fluid from flowing to the tank side cleaning fluid discharge flow path 18 side. On the other hand, by opening the first cleaning fluid discharge valve 20, the cleaning liquid pushed out from the tank cleaning flow path 13 by the discharge air is discharged to the waste liquid bath 21 through the tank side cleaning fluid discharge flow path 18. Further, by closing the first cleaning fluid discharge valve 20 after the cleaning liquid is pushed out from the tank cleaning flow path 13, the waste liquid from the waste liquid bath 21 is prevented from flowing reversely and the electrically cut-off state is maintained.

The waste liquid discharge flow path 22 connects the tank side flow path 8A of the paint flow path 8 and the waste liquid bath 21. The waste liquid discharge flow path 22 is a flow path configured to discharge waste liquid (residual paint and cleaning liquid) flowed out of the paint chamber 11B of the paint tank device 11. A waste liquid discharge fluid supply flow path 23 described later for supplying compressed air is connected to the waste liquid discharge flow path 22.

The waste liquid discharge fluid supply flow path 23 may be connected to the waste liquid discharge flow path 23 via the first discharge valve 26. In the waste liquid discharge fluid supply flow path 23, a cleaning liquid for cleaning the paint remaining in the waste liquid discharge flow path 22 and discharge air (compressed air) for discharging the cleaning liquid containing the paint from the waste liquid discharge flow path 22 circulate. The upstream side of the waste liquid discharge fluid supply flow path 23 is connected to a supply source (not shown) of a fluid containing the discharge air via a discharge fluid supply valve 24 and the downstream side thereof is connected to the first discharge valve 26. As a result, the waste liquid discharge fluid supply flow path 23 may be connected to the upstream end of the waste liquid discharge flow path 23 via the first discharge valve 26.

Further, the discharge fluid supply source includes a supply source of cleaning liquid (thinner), a supply source of compressed air used as cleaning air and discharge air, and a control valve (not shown) controlling the supply amount (e.g. supply time) of the cleaning liquid and the compressed air.

The waste liquid discharge fluid supply flow path 23 is provided with a second check valve 25. The second check valve 25 allows the cleaning fluid (including cleaning liquid) and the discharge air to circulate toward the first discharge valve 26 (waste liquid discharge flow path 22) and prevents the reverse flow. As a result, the second check valve 25 prevents the cleaning liquid and paint remaining in the waste liquid discharge flow path 22 from flowing to the discharge fluid supply valve 24 side through the waste liquid discharge fluid supply flow path 23.

Moreover, the second check valve 25 forms a part of the waste liquid discharge side control valves for supplying cleaning fluid. The waste liquid discharge side control valves include a second check valve 25, a switching valve on the cleaning liquid supply source side and a switching valve on the cleaning air supply source side.

The first discharge valve 26 is provided between every two of the tank side flow path 8A of the paint flow path 8, the waste liquid discharge flow path 22 and the waste liquid discharge fluid supply flow path 23. The first discharge valve 26 consists of a three-way two-position switching valve and connects the waste liquid discharge flow path 22 and the waste liquid discharge fluid supply flow path 23 at the initial position (basic position) shown in FIG. 2. On the other hand, when it is switched to the switched position by the control signal, the tank side flow path 8A of the paint flow path 8 and the waste liquid discharge flow path 22 can communicate.

Specifically, by connecting the waste liquid discharge flow path 22 and the waste liquid discharge fluid supply flow path 23 at the initial position of the first discharge valve 26, fluid for cleaning and discharge can be supplied from the waste liquid discharge fluid supply flow path 23 to the waste liquid discharge flow path 22. That is to say, the cleaning liquid and the cleaning air in the fluid from the waste liquid discharge fluid supply flow path 23 can clean the waste liquid adhered to the waste liquid discharge flow path 23. In addition, the discharge air in the fluid from the waste liquid discharge fluid supply flow path 23 can discharge the waste liquid (paint, cleaning liquid) remaining in the waste liquid discharge flow path 23 to the waste liquid bath 21.

On the other hand, at the switched position of the first discharge valve 26, waste liquid such as residual paint and cleaning liquid that flows from the paint chamber 11B of the paint tank device 11 to the tank side flow path 8A of the paint flow path 8 can be discharged to the waste liquid bath 21 through the waste liquid discharge flow path 22. At this time, the waste liquid discharge fluid supply flow path 23 prevents the waste liquid from flowing reversely by the second check valve 25.

The second discharge valve 27 is provided in the waste liquid discharge flow path 22 between the first discharge valve 26 and the waste liquid bath 21. The second discharge valve 27 is opened when discharging the waste liquid to the waste liquid bath 21. In addition, by closing the second discharge valve 27 after the cleaning liquid is pushed out from the waste liquid discharge flow path 22, the waste liquid from the waste liquid bath 21 is prevented from flowing reversely and the electrically cut-off state is maintained.

In the cleaning fluid flow path 28, the cleaning fluid for cleaning the rotary atomizing head 6 and the tip side of the feed tube 7 flows. The upstream side of the cleaning fluid flow path 28 is connected to the discharge air switching valve 35. As a result, the cleaning fluid flow path 28 may be connected to the atomizing head cleaning flow path 29 and the atomizing head side discharge air supply flow path 31 described later via the discharge air switching valve 35. The cleaning fluid flow path 28 is provided in the feed tube 7 along the atomizing head side flow path 8B of the paint flow path 8. Moreover, the downstream end of the cleaning fluid flow path 28 is opened on the tip side of the feed tube 7 in the rotary atomizing head 6.

The atomizing head cleaning flow path 29 connects a cleaning fluid supply source (not shown) and the cleaning fluid flow path 28. The downstream side of the atomizing head cleaning flow path 29 is connected to the cleaning fluid flow path 28 via the discharge air switching valve 35, and the cleaning fluid is supplied to the tip of the feed tube 7 and the rotary atomizing head 6. In addition, the atomizing head cleaning flow path 29 is provided with an atomizing head cleaning fluid valve 30. The atomizing head cleaning fluid valve 30 controls the supply and cessation of the cleaning fluid by allowing or cutting off flow in the atomizing head cleaning flow path 29.

The atomizing head side discharge air supply flow path 31 may be connected to the cleaning fluid flow path 28 and the atomizing head cleaning flow path 29 via the discharge air switching valve 35. Discharge air (compressed air) flows through the atomizing head side discharge air supply flow path 31. The discharge air discharges the cleaning liquid remaining in the cleaning fluid flow path 28 and the atomizing head cleaning flow path 29. The upstream side of the atomizing head side discharge air supply flow path 31 is connected to the second discharge air supply valve 32 and the downstream side thereof is connected to the discharge air switching valve 35. The atomizing head side discharge air supply flow path 31 is connected to an discharge air supply source (not shown).

The atomizing head side discharge air supply flow path 31 is provided with a third check valve 33. The third check valve 33 allows the discharge air to circulate toward the discharge air switching valve 35 (the cleaning fluid flow path 28 and the atomizing head cleaning flow path 29) and prevents the reverse flow. As a result, the third check valve 33 prevents a part of the cleaning liquid flowing from the atomizing head cleaning flow path 29 to the cleaning fluid flow path 28 from flowing to the second discharge air supply valve 32 side through the atomizing head side discharge air supply flow path 31.

The upstream side of the atomizing head side cleaning fluid discharge flow path 34 is connected to the atomizing head cleaning flow path 29 at a connection point D located between the atomizing head cleaning fluid valve 30 and the discharge air switching valve 35. The connection point D is immediately after the downstream side of the atomizing head cleaning fluid valve 30 in the flow direction of the cleaning fluid. In addition, the downstream side of the atomizing head side cleaning fluid discharge flow path 34 is connected to the waste liquid tank 21.

The discharge air switching valve 35 is provided between every two of the cleaning fluid flow path 28, the atomizing head cleaning flow path 29 and the atomizing head side discharge air supply flow path 31. The discharge air switching valve 35 consists of a three-way two-position switching valve and connects the atomizing head cleaning flow path 29 and the atomizing head side discharge air supply flow path 31 at the initial position (basic position) shown in FIG. 2. On the other hand, at the switched position switched by the control signal, the atomizing head cleaning flow path 29 and the atomizing head side discharge air supply flow path 31 can communicate with the cleaning fluid flow path 28.

Specifically, at the initial position of the discharge air switching valve 35, the discharge air may be supplied from the atomizing head side discharge air supply flow path 31 to the atomizing head cleaning flow path 29. The discharge air from the atomizing head side discharge air supply flow path 31 can discharge the cleaning liquid (cleaning fluid) remaining in the atomizing head cleaning flow path 29. On the other hand, at the switched position of the discharge air switching valve 35, cleaning liquid may be supplied from the atomizing head cleaning flow path 29 to the cleaning fluid flow path 28, and discharge air may be supplied from the atomizing head side discharge air supply flow path 31 to the cleaning fluid flow path 28.

The atomizing head side cleaning fluid discharge flow path 34 is provided with a second cleaning fluid discharge valve 36. The second cleaning fluid discharge valve 36 allows or cuts off flow of the atomizing head side cleaning fluid discharge flow path 34. When the atomizing head cleaning fluid valve 30 is opened, the second cleaning fluid discharge valve 36 is closed to prevent the cleaning liquid from flowing to the atomizing head side cleaning fluid discharge flow path 34 side. On the other hand, by opening the second cleaning fluid discharge valve 36, the cleaning fluid pushed out from the atomizing head cleaning flow path 29 by the discharge air is discharged to the waste liquid bath 21 through the atomizing head side cleaning fluid discharge flow path 34. Further, by closing the second cleaning fluid discharge valve 36 after the cleaning liquid is pushed out from the atomizing head cleaning flow path 29, the waste liquid from the waste liquid bath 21 is prevented from flowing reversely and the electrically cut-off state is maintained.

As shown in FIG. 1, the control device 37 performs various controls of the electrostatic coating device 1 by outputting control signals to electrical components mounted to the electrostatic coating device 1. As an example of such control, the control for cleaning the paint chamber 11B is performed after the coating by the coating machine 3 is completed until the paint inflow port 2C of the housing 2 is connected to the CCVU.

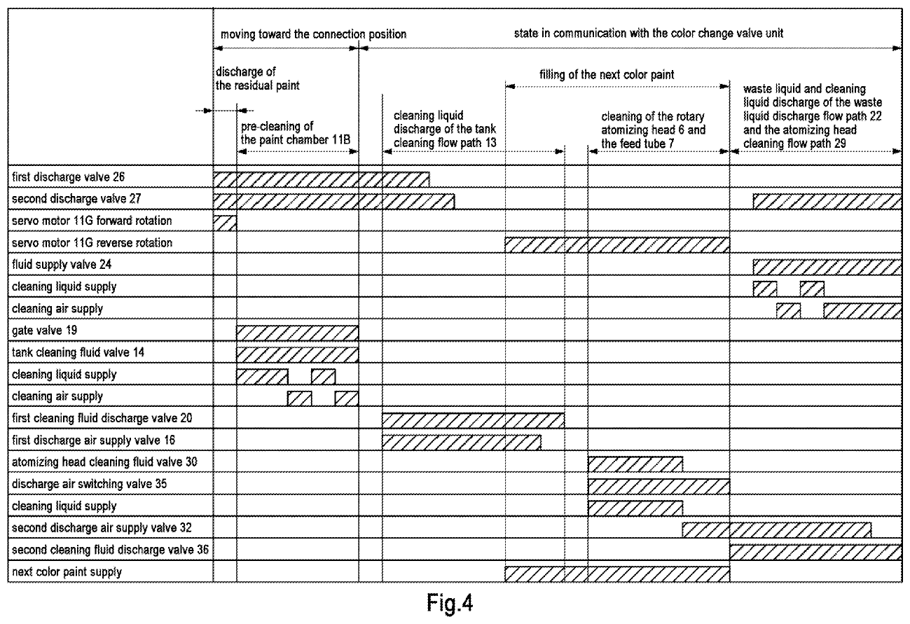

The paint tank-equipped electrostatic coating device 1 according to the present embodiment has the configuration as described above. Next, as an example of the control by the control device 37, the operation when changing the color to the next color paint after finishing the coating operation for the coated object will be described with reference to the time chart of FIG. 4.

In this color change operation, various tasks are performed, including discharging the previous color paint (residual paint) remaining in the paint chamber 11B of the paint tank device 11, pre-cleaning of the paint chamber 11B, discharging the cleaning liquid in the tank cleaning flow path 13, cleaning of the rotary atomizing head 6 and the tip of the feed tube 7, filling the paint chamber 11B with the next color paint, cleaning the waste liquid discharge flow path 22 and discharging the cleaning liquid, and discharging of the cleaning liquid in the atomizing head cleaning flow path 29. These operations are performed every time a coated object is coated, which becomes an obstacle to improving productivity.

However, in the paint tank-equipped electrostatic coating device 1 according to the present embodiment, by performing the operation of discharging the previous color paint (residual paint) remaining in the paint chamber 11B and pre-cleaning the paint chamber 11B after the coating by the coating machine 3 is completed until the paint inflow port 2C of the housing 2 is connected to the CCVU, it is possible to shorten the time of the color change operation and improve the productivity.

The specific color change work will be described below. When the coating operation for the coated object is completed, the electrostatic coating device 1 is moved from the coating area to a connection position with the CCVU provided in the color change area. During moving the electrostatic coating device 1 toward the connection position with the CCVU, the previous color paint (residual paint) remaining in the paint chamber 11B is discharged, and the pre-cleaning operation of the paint chamber 11B is performed.

In the operation of discharging the previous color paint (residual paint) remaining in the paint chamber 11B, the first discharge valve 26 is switched to the switched position, and the tank side flow path 8A of the paint flow path 8 is connected with the waste liquid discharge flow path 22. In addition, the second discharge valve 27 is switched to the open side so that the waste liquid discharge flow path 22 is in a communicated state. In this state, the servo motor 11G of the paint tank device 11 is rotated and the piston 11C is moved in the A direction shown by the arrow. Therefore, the residual paint in the paint chamber 11B is pushed out to the tank side flow path 8A of the paint flow path 8 and discharged to the waste liquid bath 21 through the waste liquid discharge flow path 22.

When mechanical discharge of the residual paint by the servo motor 11G of the paint tank device 11 is completed, the operation proceeds to the pre-cleaning of the paint chamber 11B, which includes discharge and cleaning of the residual paint using a cleaning fluid.

In the pre-cleaning of the paint chamber 11B, the gate valve 19 is switched to the switched position while the first discharge valve 26 and the second discharge valve 27 are kept switched, so that the tank cleaning flow path 13 is connected with the filling flow path 12 (paint chamber 11B). In addition, the tank cleaning fluid valve 14 is switched to the open side and the tank cleaning flow path 13 is connected to the supply source of cleaning liquid and the supply source of cleaning air. In this state, the cleaning liquid and the cleaning air are alternately supplied so that the cleaning fluid containing the cleaning liquid and the cleaning air is supplied to the paint chamber 11B through the tank cleaning flow path 13 and the filling flow path 12.

The cleaning fluid supplied to the paint chamber 11B cleans the residual paint remaining in (adhering to) the paint chamber 11B and flows out as waste liquid containing paint to the tank side flow path 8A of the paint flow path 8. Since most of the waste liquid is a cleaning fluid, it is possible to clean the tank side flow path 8A and the waste liquid discharge flow path 22 while being discharged to the waste liquid bath 21 through the tank side flow path 8A and the waste liquid discharge flow path 22.

By completing the preceding operations before connecting the electrostatic coating device 1 to the CCVU, the operation time from the connection to the CCVU can be shortened.

Next, as shown in FIG. 3, the electrostatic coating device 1 is connected to the CCVU. While the electrostatic coating device 1 is connected to the CCVU, the paint chamber 11B is fully cleaned (formal cleaned), which is omitted herein. Upon the electrostatic coating device 1 being connected to the CCVU, the operation proceeds to the discharge operation of the cleaning liquid remaining in the tank cleaning flow path 13. First, the first cleaning fluid discharge valve 20 and the first discharge air supply valve 16 are switched to the open side and discharge air is supplied to the tank side discharge air supply flow path 15. At this time, since the gate valve 19 has been returned to the initial position, the discharge air flows through the tank cleaning flow path 13 and the tank side cleaning fluid discharge flow path 18, and the remaining cleaning liquid is discharged to the waste liquid bath 21 as the waste liquid. As a result, the tank cleaning flow path 13 is cleaned and becomes empty, thereby preventing high voltage leakage.

Next, the rotary atomizing head 6 and the tip of the feed tube 7 is cleaned. In this case, the atomizing head cleaning fluid valve 30 is switched to the open side, and the discharge air switching valve 35 is switched to the switched position so that the atomizing head cleaning flow path 29 and the atomizing head side discharge air supply flow path 31 is connected to the cleaning fluid flow path 28. Moreover, by supplying cleaning liquid to the atomizing head cleaning flow path 29, the cleaning liquid can be sprayed from the cleaning fluid flow path 28 to clean the rotary atomizing head 6 and the tip of the feed tube 7.

In addition, the operation of filling the next color paint to the paint chamber 11B of the paint tank device 11 is carried out simultaneously with the discharge operation of the cleaning liquid of the tank cleaning flow path 13 and the cleaning operation of the rotary atomizing head 6 and the tip of the feed tube 7. In the filling operation, the next color paint is supplied from the paint inflow port 2C of the housing 2 to the paint chamber 11B through the filling flow path 12. At this time, the servo motor 11G of the paint tank device 11 rotates according to the filling flow rate of the paint, moving the piston 11C in the B direction shown by the arrow.

Next, the cleaning operation of the waste liquid discharge flow path 22 and the discharge operation of waste liquid are performed. First, the second discharge valve 27 and the discharge fluid supply valve 24 are switched to the open side. In this state, cleaning liquid and cleaning air are supplied to the waste liquid discharge fluid supply flow path 23 to clean the waste liquid adhering to the waste liquid discharge flow path 23, and discharge the waste liquid to the waste liquid bath 21 together with the cleaning liquid. As a result, the waste liquid discharge flow path 22 is cleaned and becomes empty, thereby preventing high voltage leakage.

The discharge operation of the cleaning liquid of the atomizing head cleaning flow path 29 is performed simultaneously with the cleaning and discharge operations of the waste liquid discharge flow path 22. In this operation, the second discharge air supply valve 32 is switched to the open side and discharge air is supplied to the atomizing head side discharge air supply flow path 31. When the supply of discharge air is started, since the discharge air switching valve 35 is in a switched state, discharge air is supplied to the cleaning fluid flow path 28 to discharge the cleaning fluid remaining in the cleaning fluid flow path 28. As a result, cleaning fluid is prevented from dripping from the cleaning fluid flow path 28.

Subsequently, the discharge air switching valve 35 is switched to the initial position and the second cleaning fluid discharge valve 36 is switched to the open side while the second discharge air supply valve 32 remains switched to the open side. At this time, the discharge air is supplied to the atomizing head cleaning flow path 29 and the atomizing head side cleaning fluid discharge flow path 34 to discharge the cleaning liquid remaining in the atomizing head cleaning flow path 29. As a result, the atomizing head cleaning flow path 29 is cleaned and becomes empty, thereby preventing high voltage leakage.

Therefore, according to the present embodiment, the paint tank-equipped electrostatic coating device 1 includes: a tank cleaning flow path 13 which supplies cleaning fluids for cleaning a paint chamber 11B of a paint tank device 11; a waste liquid discharge flow path 22 configured to discharge the waste liquid flowed out of the paint chamber 11B; and a control device 37 which performs control for cleaning the paint chamber 11B after the coating by the coating machine 3 is completed until the paint inflow port 2C of the housing 2 is connected to the CCVU.

Therefore, during moving the electrostatic coating device 1 toward the connection position with the CCVU, the previous color paint (residual paint) remaining in the paint chamber 11B can be discharged, and the pre-cleaning operation of the paint chamber 11B can be performed. As a result, the time of color change operation can be shortened and thereby the productivity can be improved.

The tank side discharge air supply flow path 15 for supplying compressed air is connected to the tank cleaning flow path 13. In addition, a waste liquid discharge fluid supply flow path 23 for supplying compressed air is connected to the waste liquid discharge flow path 22. Therefore, it is possible to prevent the high voltage applied to the paint from leaking through the tank cleaning flow path 13 and the waste liquid discharge flow path 22.

The tank cleaning flow path 13 is provided with a tank cleaning fluid valve 14 forming a part of the tank side control valves for supplying cleaning liquid. Therefore, an appropriate amount of cleaning liquid can be supplied to the paint chamber 11B. In addition, the waste liquid discharge fluid supply flow path 23 is provided with a second check valve 25 which forms a part of the waste liquid discharge side control valves for supplying cleaning fluid. Therefore, an appropriate amount of cleaning liquid, cleaning air and discharge air can be supplied to the waste liquid discharge flow path 22.

The tank side discharge air supply flow path 15 is provided with a first check valve 17 which allows compressed air to circulate toward the tank cleaning flow path 13 and prevents the reverse flow. As a result, the first check valve 17 can prevent the cleaning liquid remaining in the tank side discharge air supply flow path 15 from flowing to the first discharge air supply valve 16 side through the tank side discharge air supply flow path 15.

In addition, the waste liquid discharge fluid supply flow path 23 is provided with a second check valve 25 which allows cleaning fluid and discharge air to circulate toward the waste liquid discharge flow path 22 and prevents the reverse flow. As a result, the second check valve 25 prevents the waste liquid from flowing to the discharge fluid supply valve 24 side through the waste liquid discharge fluid supply flow path 23.

Further, in the embodiment, a case in which the high voltage generator 10 is provided in the housing 2 is shown. However, the present invention is not limited thereto and a configuration in which the high voltage generator is provided to a location other than the housing, e.g., a painting robotic arm may also be adopted.

### REFERENCE SIGNS LIST

1 paint tank-equipped electrostatic coating device
2 housing
2C paint inflow port
3 coating machine
4 air motor
5 rotating shaft
6 rotary atomizing head
8 paint flow path
10 high voltage generator
11 paint tank device
11A tank body (paint tank)
11B tank chamber
11G servo motor
13 tank cleaning flow path
14 tank cleaning fluid valve (tank side control valve)
15 tank side discharge air supply flow path
17 first check valve
22 waste liquid discharge flow path
23 waste liquid discharge fluid supply flow path 23
25 second check valve (waste liquid discharge side control valve)
37 control device
CCVU color change valve unit

1. A paint tank-equipped electrostatic coating device, comprising:
a housing having a paint inflow port connected to a color change valve unit for changing a color of a paint;
a coating machine which is provided in the housing, wherein the coating machine includes an air motor having a hollow rotating shaft and a rotary atomizing head mounted to the hollow rotating shaft in front of the air motor;
a paint flow path which extends toward the rotary atomizing head in the hollow rotating shaft and through which the paint supplied to the rotary atomizing head circulates;
a paint tank device which is provided in the housing, wherein the paint tank device is configured to supply the paint stored in a paint chamber to the rotary atomizing head through the paint flow path;
a high voltage generator which applies a high voltage to the paint discharged from the paint flow path;
a tank cleaning flow path, wherein the tank cleaning flow path is configured to supply cleaning fluids for cleaning the paint chamber of the paint tank device;
a waste liquid discharge flow path configured to discharge a waste liquid flowed out of the paint chamber; and
a control device configured to perform control for cleaning the paint chamber after coating by the coating machine is completed until the paint inflow port of the housing is connected to the color change valve unit.

2. The paint tank-equipped electrostatic coating device of claim 1, further comprising:
a tank side discharge air supply flow path for supplying compressed air connected to the tank cleaning flow path; and
a waste liquid discharge fluid supply flow path for supplying compressed air connected to the waste liquid discharge flow path.

3. The paint tank-equipped electrostatic coating device of claim 2,
wherein the tank cleaning flow path is provided with a tank side control valve for supplying cleaning liquid, and
the waste liquid discharge fluid supply flow path is provided with a waste liquid discharge side control valves for supplying cleaning fluid.

4. The paint tank-equipped electrostatic coating device of claim 2,
wherein the tank side discharge air supply flow path is provided with a first check valve which allows the compressed air to circulate toward the tank cleaning flow path and prevents the reverse flow, and
the waste liquid discharge fluid supply flow path is provided with a second check valve which allows the compressed air to circulate toward the waste liquid discharge flow path and prevents the reverse flow.
